(19) United States
(12) Patent Application Publication
(10) Pub. No.: US 2010/0141720 A1
(43) Pub. Date: Jun. 10, 2010

(54) SPREADING AND LEVELING OF CURABLE GEL INK

(75) Inventors: Steven E. Ready, Los Antos, CA (US); Jurgen H. Daniel, San Francisco, CA (US); Bryan J. Roof, Newark, NY (US); Gregory J. Kovacs, Webster, NY (US)

Correspondence Address: MARGER JOHNSON & MCCOLLOM/PARC, 210 MORRISON STREET, SUITE 400, PORTLAND, OR, 97204, US

(73) Assignee: PALO ALTO RESEARCH CENTER INCORPORATED, Palo Alto, CA (US)

(21) Appl. No.: 12/331,076

(22) Filed: Dec. 9, 2008

(51) Int. Cl. B41J 2/175

(52) U.S. Cl. 347/88

(57) ABSTRACT

A method of leveling a curable phase-change ink on a surface includes printing the curable phase-change ink onto a transfer surface, pressing the transfer surface onto a print substrate with sufficient pressure to level the ink, and exposing the curable phase-change ink to radiation through the transfer surface to cure the phase-change ink. A method for leveling a region of a printed surface includes printing curable phase-change ink onto a surface, pressing a leveling surface onto the print surface to contact a region of the curable phase-change ink, and exposing the curable phase-change ink through the leveling surface to radiation to cure the phase-change ink.

### RELATED APPLICATIONS

Cross-reference is hereby made to the following US patent applications, assigned to the assignee hereof: U.S. application Ser. No. 12/256,670 (Attorney File No. 20080183-US-NP), U.S. application Ser. No. 12/256,684 (Attorney File No. 20080187-US-NP), U.S. application Ser. No. 12/256,690 (Attorney File No. 20080212-US-NP), U.S. application Ser. No. 11/291,284, filed Nov. 30, 2005, now US Patent Application Publication US 2007/0120930 A1 (Attorney File No. 20040629-US-NP), and U.S. patent application Ser. No. 12/324,069, (Attorney File No. 20080178-US-NP).

### BACKGROUND

In striving to produce clear, sharp and colorful images, printer equipment manufacturers have explored many different types of inks and toners. Gel ink is a relatively new type of ink. A gel is an ink that is neither solid nor liquid when it is applied to the print surface. They solidify rapidly upon cooling, and therefore have advantages over water or solvent based inks that may de-wet from many surfaces, such as plastics, cardboard, etc.

Issues arise with gel inks in their transfer to the print surface, also referred to as the print or image substrate. For example, in solid ink printers, the ink first takes the form of a solid similar to wax. The printer melts the ink, generally in stick form, and transports it through a heated pathway to a print head that then uses the now liquid ink to form printed images. The printer may be an inkjet printer. As a liquid, the hot melted ink does not stick to many of the surfaces of the printer. When the ink cools, it becomes solid again and can be scraped off or otherwise removed as well.

Gel inks typically do not smear or run without some sort of force being applied. Without any interference, the gel inks will stay on the print substrate. Smearing without any outside force may happen with liquid inks, whether molten liquid or inks provided originally in liquid form. Gel inks can have high pigmentation because of their viscosity, resulting in images which have high optical density and hence good color depth.

However, gel inks require some type of transformation such as curing to prevent them from running or smearing when printed onto a substrate and subjected to general handling. In addition, uncured gel inks stick to all roller surfaces in print paths, making them unsuitable for many printing applications without some sort of transformation or curing.

### BRIEF DESCRIPTION OF THE DRAWINGS

FIG. 1 shows an embodiment of a printing system using curable, phase-change inks and a leveling surface.

FIG. 2 shows an embodiment of a printing system using curable, phase-change inks and a leveling, transfer surface.

FIG. 3 shows another embodiment of a printing system using curable, phase-change inks and a transfer roller.

FIG. 4 shows an embodiment of a method of curing phase-change inks in a printing system using a leveling surface and at least one transparent roller.

### DETAILED DESCRIPTION OF THE EMBODIMENTS

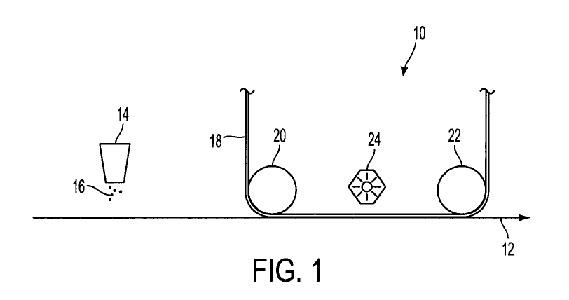

FIG. 1 shows an embodiment of a printing system 10. The printing system has a print head 14 that transfers ink 16 to print media 12. The print head may be a digital, electronically addressed printhead such as in an ink jet printer, in which ink is dispensed via an array of nozzles from an ink reservoir, or a flexographic print head, in which ink is deposited onto a print surface by direct contact with the ink and then transferred to the print media again by direct contact between the print surface and the print media. Other printing methods such as screen printing, gravure printing, pad printing or offset printing may also be chosen. The simplification of the print head 14 in FIG. 1 is not intended to imply any particular type of printing system, and should not be used to limit application or scope of the claims.

The printing system 10 uses a leveling surface 18. In this embodiment, the leveling surface is a plastic or other flexible sheet 18. The leveling surface can be any surface that can contact an image printed using phase-change inks and cause the ink to spread out locally and attain a more uniform, level depth of ink on the substrate. In one form, a phase-change ink has a low viscosity above a certain temperature T1 and a high viscosity at a lower temperature T2. Some phase-change inks, especially gels, have relatively low viscosity and tend to have low cohesiveness. The result is that the ink layer splits when adhered to two surrounding surfaces which are then separated, rather than releasing from either surrounding surface. The freezing or gelling of the ink on a relatively cool substrate can cause local unevenness in an image. This is especially true where there is a higher volume of ink, as higher volumes of ink tend to ‘build up’ on the print substrate in the areas directly under the passed nozzles and as a result produce more print depth in these areas.

Application of a leveling surface serves to spread out the ink in local print features, across pixel level distances. The spreading action cannot propagate much beyond pixel level distances, otherwise the image would be effectively destroyed.

In the printing system 10 of FIG. 1, the print media 12, such as paper, plastic, cardboard, metal, transparency film etc., moves along the path shown. As the media passes, the print head 14 dispenses ink 16 onto it. Inks having gel-like consistency generally stick to most surfaces within a typical printing system so the ink must be cured to the print media to ensure that it does not stick to other surfaces in the printing system. The curing process may be a cross linking process of polymer chains, monomers or oligomers in the ink. The cross linking process may be triggered for example by actinic radiation such as light, electron beams or x-ray radiation. Heat may also cause a cross linking reaction.

A leveling surface 18 is brought into contact with the printed image on the media 12 by the roller 20. A radiation source 24, such as an ultraviolet (UV) light source, then cures the ink through the leveling surface 18, which in this case is transparent. The radiation source may be any type of generator of radiation at the needed wavelength and irradiance needed to cure the ink. Examples include lamps, single light emitting diodes (LEDs), laser diodes, arrays of LEDs, etc. Generally, these inks are cured (or cross linked) using UV light, but any wavelength radiation is considered within the bounds of the invention as claimed. Examples of the leveling surface include Mylar® and other plastic sheeting including polyesters, copolyester, polysulfones, polyethersulfone, polymethylpentene, PVC, polyethylenenaphthalene, ethylene-chlorotrifluoroethylene, polycarbonate, polyetherimide, acetal copolymers, and others, the sheet being transparent or translucent to allow radiation to penetrate to the ink. It may also include thin sheets of paper or fabric or thin glass.

After the ink has cured, the leveling surface 18 is pulled away from the print media by the roller 22. The end result is that the ink is cured and it does not stick to the leveling surface 18 after curing. In order to promote the curing of the ink and subsequent removal or release of the leveling surface 18, the surface 18 may be treated with a low surface energy (hydrophobic) substance to further ensure that the ink will not stick to it. Examples of low-surface energy materials are polytetrafluoroethylene (Teflon®) with a reported surface energy of 20 mN/m, polydimthylsiloxane (PDMS) with 19.8 mN/m, Polyvinylidene fluoride (PVDF) with 30.3 mN/m, plasma polymerized hexamethyldisiloxane (HMDS) with 38 mN/m. Although low-surface energy coatings are often used as release layer, any other coating or surface deposit which adheres poorly to the leveling surface or to the ink layer may be employed as a release layer.

The release treatment may be applied by a spray or other dispenser and refreshed as needed or may be engineered into the surface itself. The treatment may consist of a release agent, either temporarily applied or permanently bonded to the surface. Examples of such low surface energy materials or surface coatings are fluoropolymers such as Cytop® manufactured by Asahi Glass or Teflon® AF manufactured by DuPont, fluorinated self assembled monolayers such as fluorosilanes, long-alkyl chain silanes, hexamethyldisilazane (HMDS), etc.

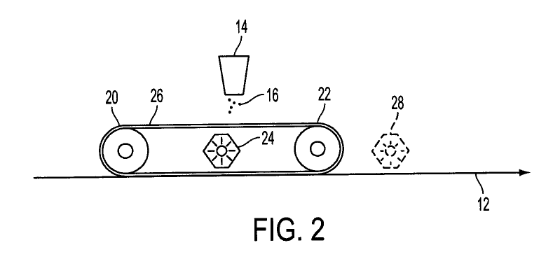

In the embodiment of FIG. 1, the ink is distributed in a ‘direct marking’ manner where the print head dispenses ink directly onto the print media. Indirect marking printing systems, those that use an intermediate transfer surface, may also employ a leveling surface. FIG. 2 shows an example.

In FIG. 2, the print head 14 dispenses ink 16 onto an intermediate transfer surface, in this instance a belt 26. The belt 26 consists of the hydrophobic surface such as the Mylar® or plastic sheet. Rollers 20 and 22 transport the ink around to come into contact with the print media 12. Once the ink has been transported onto the print media 12, it is cured by the radiation source 24.

The radiation source would desirably reside at location 24, ‘inside’ the roller/belt assembly. This allows the radiation source to cure the ink while in contact with the leveling surface. The belt 26 would consist of a transparent material to allow the radiation to transmit through it to the ink. The radiation source 24 in FIG. 2 would only radiate downwards so that the upper belt area is not exposed. As shown in FIG. 2, the radiation source may also reside outside the belt 26 at location 28 and would apply its radiation immediately after the belt 26 transfers the image to the print media 12. However, this approach may not work as well, as the curing is not applied to the ink while it is in contact with the leveling surface, increasing the likelihood of smearing the image or ink sticking to the other surfaces in the printing system.

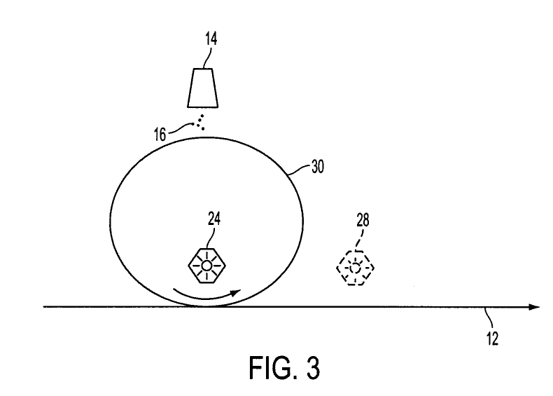

Similar to a belt intermediate transfer surface, the printing system may employ a roller or drum intermediate transfer surface. FIG. 3 shows an example of such an embodiment.

In FIG. 3, the intermediate transfer surface consists of a drum 30. The drum 30 receives the ink 16 from the print head 14. The drum 30 rotates to transfer the ink image to the media 12. The drum would have to be reasonably ‘stiff’ or rigid to press the ink down onto the media 12 and level it as part of the pressing process. The radiation source 24 then cures the ink image onto the print media 12. The drum 30 would act as the leveling surface as it presses the ink image onto the print media, and the radiation source would then cure it through the drum, the drum being able to pass the radiation of whatever wavelength used. In one example, the drum is made of glass or quartz and the surface may be treated with a low surface energy coating such as above mentioned silane coatings, or fluorocarbon coatings, etc.

Again, it is possible to place the radiation source at the location 28 to cure the image after it is transferred onto the print media 12. However, the ink may still stick to the drum, even if treated with a hydrophobic surface. Further, the image may smear or otherwise be damaged when the roller breaks contact with the print media.

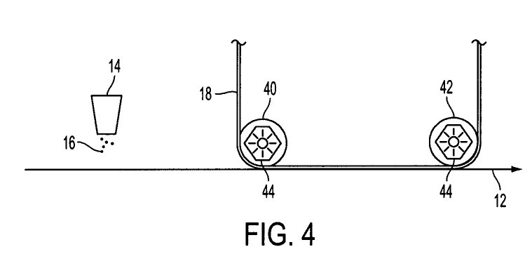

Using a transparent leveling surface allows for more flexible curing options. Returning to a printing system similar to FIG. 1 as shown in FIG. 4, the rollers 40 and 42 used to bring the leveling surface into and out of contact with the print media may also be used to contain radiation sources such as 44. This would allow the system to provide two radiation sources to cure the ink. This may have advantages in speeding up the process, as the media would be exposed twice, possibly allowing the rollers to transport the media and the leveling surface faster while still maintaining the level of irradiance or flux needed to cure the ink.

The use of a leveling surface may also provide other opportunities in the printing area. In the above discussion, it was mentioned that the leveling surface was generally a smooth, flexible sheet. “Smooth” as that term is used here means that the surface is without micro-roughness that will not impart detectable texture to the ink. This prevents any unintentional texturizing of the image.

However, it is possible to use a textured leveling surface to create a textured mat finish to the image. Using a leveling surface with an embossed or otherwise patterned surface texture, such as by laser ablation, sand blasting, etching, mechanical milling, etc., would allow the creation of a textured pattern in the ink. Using a smooth surface may allow for creation of a glossy image. Other features may be added to the ink image, including adding in diffraction gratings to the inked image by using a leveling surface with an embossed or otherwise patterned grating.

Also, as previously mentioned, a low surface energy (hydrophobic) or other engineered surface may be applied onto the leveling surface. The leveling surface, whether a sheet, roller or other form, may be treated with a temporary release agent or have a release agent permanently bonded onto it. The permanent or temporary release agent may consist of Cytop® from Asahi Glass (amorphous perfluoropolymer with high UV transmission) or DuPont's Teflon® AF fluoropolymer resin. These coatings may be deposited from solution, e.g. by dip-coating, spray coating, mist coating, doctor blading, printing methods or other deposition methods known in the art of solution processing. Other permanent or temporary coatings may consist of ORMOCER® inorganic-organic hybrid polymers and they may also be coated from a solution. Coatings that may be more suitable as permanent coatings are Parylene, in particular the fluorine group containing Parylene HT® manufactured by Specialty Coating Systems of Indianapolis, Ind., which may be deposited from a vapor phase. Moreover, a plasma coating such as by plasma polymerization from CHF3 gas or CF4/hydrocarbon mixtures or of hexafluoroacetone/hydrocarbon such as acetylene mixtures may form a permanent release layer.

Other potential release layers may be based on transparent superhydrophobic silica or on porous alumina coatings. Other release layers commonly used for releasing molds in molding processes may also be used. These include fluorinated coatings or materials such as NanoMouldRelease by BPI Technology, Ltd. of Singapore. If the layer is permanently bonded to the leveling surface, it may not have to be replaced after each print cycle. If the layer is temporarily applied, it may be freshly coated onto the leveling surface before contacting the ink, and after release, the layer may be removed, such as by a solvent and mechanical wiping. Subsequently, a new layer of the release coating may be applied.

It will be appreciated that several of the above-disclosed and other features and functions, or alternatives thereof, may be desirably combined into many other different systems or applications. Also various presently unforeseen or unanticipated alternatives, modifications, variations, or improvements therein may be subsequently made by those skilled in the art which are also intended to be encompassed by the following claims.

What is claimed is:

1. A method for leveling a region of a printed surface, comprising:
printing curable phase-change ink onto a surface;
pressing a leveling surface onto the print surface to contact a region of the curable phase-change ink; and
exposing the curable phase-change ink through the leveling surface to radiation to cure the phase-change ink.

2. The method of claim 1, further comprising removing the leveling surface from the print surface.

3. The method of claim 1, wherein printing comprises one of either printing using ink jets or printing using flexographic printing.

4. The method of claim 1, wherein pressing a leveling surface comprises pressing a flexible, radiation transparent surface.

5. The method of claim 4, wherein the flexible, radiation transparent surface is a low surface energy surface.

6. The method of claim 5, further comprising modifying the flexible, radiation transparent surface with one of either a permanently bonded release agent or a temporarily applied release agent.

7. The method of claim 1, wherein pressing a leveling surface comprises pressing a radiation transparent roller.

8. The method of claim 7, further comprising surface modifying the radiation transparent roller with one of either a permanently bonded release agent or a temporarily applied release agent.

9. The method of claim 1, wherein exposing the curable phase-change ink comprises exposing the ink through a radiation transparent film.

10. The method of claim 1, wherein exposing the curable phase-change ink comprises exposing the ink through a radiation transparent roller.

11. The method of claim 1, wherein exposing the curable phase-change ink comprises exposing the ink to ultraviolet radiation.

12. The method of claim 1, wherein pressing the leveling surface comprises pressing one of either a smooth leveling surface to result in a glossy finish, or a textured leveling surface to result in a matte finish.

13. A method of leveling a curable phase-change ink on a surface, comprising:
printing the curable phase-change ink onto a transfer surface;
pressing the transfer surface onto a print substrate with sufficient pressure to level the ink; and
exposing the curable phase-change ink to radiation through the transfer surface to cure the phase-change ink.

14. The method of claim 13, further comprising removing the transfer surface from the print substrate.

15. The method of claim 13, wherein pressing the transfer surface further comprises pressing one of either a radiation transparent film or a radiation transparent roller.

16. The method of claim 15, wherein exposing the ink to radiation comprises exposing the ink through the radiation transparent film or from inside the transparent roller.

17. The method of claim 13, further comprising treating the transfer surface with one of either a permanently bonded release agent or a temporarily applied release agent prior to pressing the transfer surface onto the print substrate.
